(19) United States
(12) Patent Application Publication
(10) Pub. No.: US 2007/0268381 A1
(43) Pub. Date: Nov. 22, 2007

(54) Method and Device for the Automatic Processing of Spontaneous Data

(75) Inventors: Rene Gastinger, Rennes (FR); Christophe Cutullic, Domloup (FR); Erich Decerf, Fougeres (FR)

Correspondence Address: COHEN, PONTANI, LIEBERMAN & PAVANE, 551 FIFTH AVENUE, SUITE 1210, NEW YORK, NY, 10176, US

(73) Assignee: France Telecom, Paris (FR)

(21) Appl. No.: 10/592,582

(22) PCT Filed: Mar. 10, 2005
(86) PCT No.: PCT/FR05/00572

§ 371 Date: Jul. 25, 2007

(30) Foreign Application Priority Data
Mar. 12, 2004 (FR) 04 02591

(51) Int. Cl. H04N 5/76

(52) U.S. Cl. 348/231.2; 707/102

(57) ABSTRACT

According to the invention, a first characteristic (CAR1, CAR2) is associated with the spontaneous information (I1, I2) and/or a second characteristic (CART) with a stream reproducer terminal (T). The reproduction of a multimedia stream (F1, F2) on the reproducer terminal (T) automatically triggers the sending of the first and/or second characteristic (CAR1, CAR2, CART) to an analysis filter (FA) in order to send the spontaneous information (I1, I2) to the reproducer terminal (T) or not as a function of the first and/or the second characteristic (CAR1, CAR2, CART). The first and/or second characteristic (CAR1, CAR2, CART) may include an indicator (A1, A2, AT) of immediate or deferred reproduction. The reproducer terminal (T) reproduces the spontaneous information (I1, I2) when it has been sent to it.

The invention relates to a method and apparatus for automatic processing of spontaneous information that has to be reproduced on a terminal together with a multimedia stream.

One field of application of the invention is audio and/or video streams such as recorded or broadcast television transmissions, live or otherwise, films broadcast on television, and video on demand (VOD).

For example, the spontaneous information is intended to be reproduced temporarily on the terminal, in addition to the multimedia stream, which may then be considered as a multimedia stream presenting a main content, so that the spontaneous information may be considered as presenting accessory content. By way of example, the spontaneous information may be associated with the multimedia stream in the sense that it is linked to the content of the multimedia stream and may be produced by the same entity as that supplying the multimedia stream.

For example, the spontaneous information may designate messages displayed on the screen of the reproducer terminal in addition to the image transported by the multimedia stream and occupying a portion thereof. For example, these messages may be fixed images, also known as embedded messages, displayed for a few seconds, for example to indicate an address and/or a telephone number, to invite the viewer to make a donation or to participate in a game or a vote, or for other purposes. These messages may equally well be a banner displayed at the bottom of the screen for scrolling text. The spontaneous information may also be referred to as a window or an advertisement or a “pop-up”. The spontaneous information is not necessarily synchronized with the multimedia stream and may be independent of it, as in the case of advertising, for example.

The user of the terminal does not always want to view this spontaneous information when receiving the multimedia stream on a terminal.

Some users consider this spontaneous information to be undesirable, masking and polluting the reproduction of the multimedia stream offered to them by their terminals.

The user may be relatively unreceptive to this spontaneous information and it may divert the user's attention for no good reason and cause the user to lose the thread of the audiovisual content present in the main multimedia stream. The user may even be obliged to acknowledge this information to cause it to disappear from the terminal and allow normal reproduction of the main stream thereon to resume.

The invention aims to provide a method and apparatus that alleviate the drawbacks mentioned above and improve the user comfort and user friendliness of reproduction on the terminal.

To this end, a first aspect of the invention consists in a method of automatically processing spontaneous information intended to be reproduced on a reproducer terminal with a multimedia stream,

the method being characterized in that

each spontaneous information item is associated with at least one first spontaneous information characteristic from a group comprising a plurality of prescribed spontaneous information characteristics, and/or the reproducer terminal is associated with at least one second spontaneous information characteristic from a group comprising a plurality of prescribed spontaneous information characteristics,

the reproduction of a multimedia stream on the reproducer terminal automatically triggers

the sending of the first and/or the second spontaneous information characteristic present to an analysis filter, for sending the spontaneous information to the reproducer terminal or not, as a function at least of the first and/or the second spontaneous information characteristics sent to the analysis filter,

the reproducer terminal reproducing the spontaneous information when it has been sent to it.

By means of the invention, the user is able to monitor in advance and to filter the reproduction of the spontaneous information on the terminal. Accordingly, only reproduction on the terminal of spontaneous information that the user deems pertinent will be authorized by the analysis filter, and other spontaneous information will not be sent to the terminal, will therefore be ignored, and will not interfere with the presentation of the content of the current multimedia stream.

According to other, non-limiting features of the invention:

each spontaneous information item is associated with at least one first spontaneous information characteristic from the group comprising a plurality of prescribed spontaneous information characteristics, and the reproducer terminal is associated with at least one second spontaneous information characteristic from the group comprising a plurality of prescribed spontaneous information characteristics,

the reproduction of the multimedia stream on the reproducer terminal triggers automatically,

the sending of the first and second spontaneous information characteristics to the analysis filter, for sending the spontaneous information to the reproducer terminal or not, as a function at least of the first and the second spontaneous information characteristics sent to the analysis filter,

the reproducer terminal reproducing the spontaneous information when it has been sent to it;

said at least one first spontaneous information characteristic of the spontaneous information comprises at least one first theme relating to a spontaneous information multimedia content and at least one second spontaneous information characteristic of the terminal comprises at least one second theme relating to a spontaneous information multimedia content,

the analysis filter comparing the first theme of the spontaneous information to the second theme of the terminal to authorize sending the spontaneous information to the reproducer terminal if the comparison determines that the first theme is found in the second theme and not to authorize sending the spontaneous information to the reproducer terminal if the comparison determines that the first theme is not found in the second theme;

the second spontaneous information characteristic is associated with an identifier of the reproducer terminal on a management server remote from the reproducer terminal in at least one table, the analysis filter being in the management server, and

the reproduction of the multimedia stream on the reproducer terminal automatically triggers consultation by the analysis filter of the second spontaneous information characteristic associated with the identifier of the reproducer terminal in the identification table;

the association of the second spontaneous characteristic with the identifier of the reproducer terminal in the table is executed from the reproducer terminal;

said at least one first spontaneous information characteristic of the spontaneous information comprises at least one first reproduction indicator, intended for the terminal, and/or said at least one second spontaneous information characteristic of the terminal comprises at least one second reproduction indicator, intended for the terminal,

the analysis filter commanding, in the event of authorization, the sending of the spontaneous information to the reproducer terminal in conformance with the second reproduction indicator of the terminal or, in the absence of the second reproduction indicator of the terminal, in conformance with the first reproduction indicator of the spontaneous information;

the second theme of the terminal is associated with the identifier of the reproducer terminal in a table of interests in the management server,

and/or the second reproduction indicator of the terminal is associated with the identifier of the reproducer terminal in a table of indicators in the management server,

and the reproduction of the multimedia stream on the reproducer terminal automatically triggers consultation by the analysis filter of the second theme associated with the identifier of the reproducer terminal in the table of interests and, in the event of authorization to send the spontaneous information, triggers consultation by the analysis filter of the second reproduction indicator associated with the identifier of the reproducer terminal in the table of indicators or, in the absence of a second reproduction indicator, consultation by the analysis filter of the first reproduction indicator;

the first reproduction indicator of the spontaneous information and/or the second reproduction indicator of the terminal are each selected from an indicator of immediate reproduction on the terminal to command the immediate sending of the spontaneous information to the reproducer terminal and an indicator of non-immediate reproduction to command the sending of the spontaneous information to the reproducer terminal in the event of detection of a particular triggering event by the analysis filter;

the triggering event is one of the following events: the end of the reproduction of the multimedia stream on the terminal, the sending on the terminal of a request for stopping the reproduction of the stream, the stopping on the terminal of the reproduction of the stream, the switching of the terminal to another stream or program, a predefined time of reproduction of the spontaneous information on the terminal, a prescribed period for deferring the reproduction of the spontaneous information on the terminal, a prescribed period for deferring the reproduction of the spontaneous information on the terminal after the reproduction thereon of a previous spontaneous information item, and an action of the user on the terminal;

the first spontaneous information characteristic is associated with the spontaneous information in a database remote from the reproducer terminal providing the spontaneous information, and

the reproduction of the multimedia stream on the reproducer terminal automatically triggers consultation by the analysis filter of the first spontaneous information characteristic associated with the spontaneous information in the database.

A second aspect of the invention consists in apparatus for implementing the automatic processing method according to any preceding claim to process automatically spontaneous information intended to be reproduced on a reproducer terminal with a multimedia stream, the apparatus being characterized in that it comprises:

at least one database remote from the reproducer terminal providing spontaneous information and in which each spontaneous information item is associated with at least one first spontaneous information characteristic from a group comprising a plurality of prescribed spontaneous information characteristics,

at least one remote management server for associating with the production terminal, in at least one table, at least one second spontaneous information characteristic from the group of prescribed spontaneous information characteristics,

means for automatically triggering in the management server, when a multimedia stream is reproduced on the reproducer terminal, consultation of the first characteristic associated with the spontaneous information in the database and of the second characteristic associated with reproducer terminal in the table, and sending to an analysis filter in the management server of the first and second characteristics obtained, the analysis filter including means for sending or not sending the spontaneous information to the reproducer terminal as a function at least of the first and second characteristics sent to the analysis filter, the reproducer terminal including means for reproducing the spontaneous information when it has been sent to it.

The invention can be better understood on reading the following description, which is given by way of non-limiting example only and with reference to the appended drawings, in which:

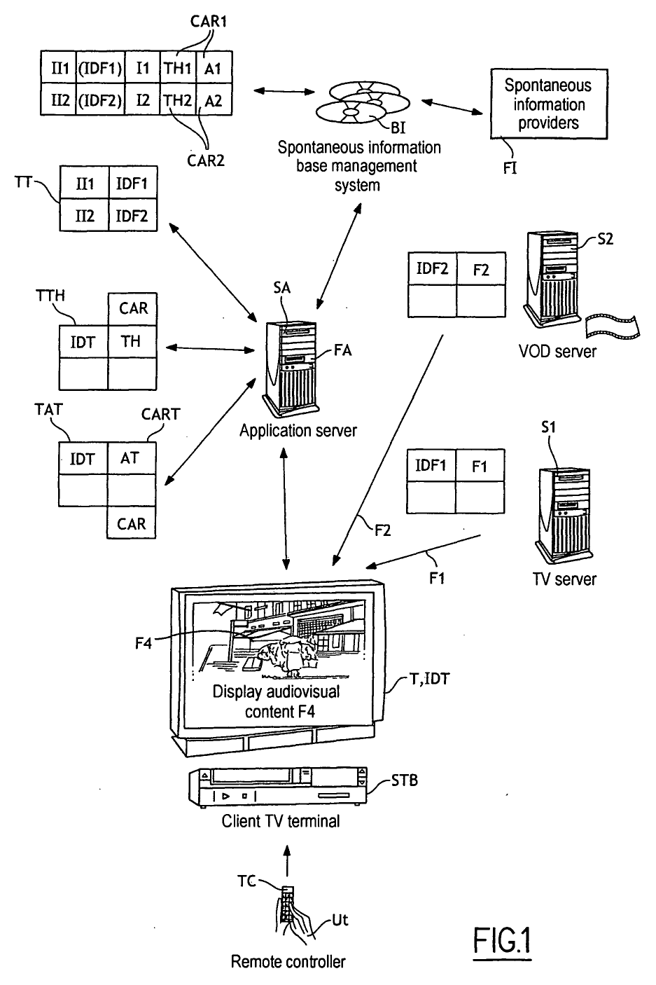

FIG. 1 is a diagram of one example of apparatus for automatically processing spontaneous information using the method of the invention for automatic processing of spontaneous information;

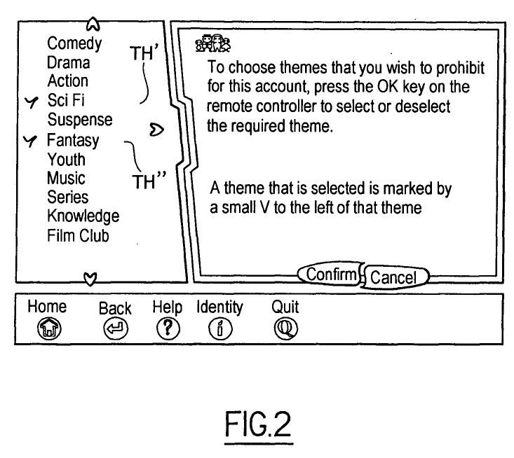

FIG. 2 is a diagram of a user interface on the user's terminal during a phase of initializing the method of the invention for automatic processing of spontaneous information;

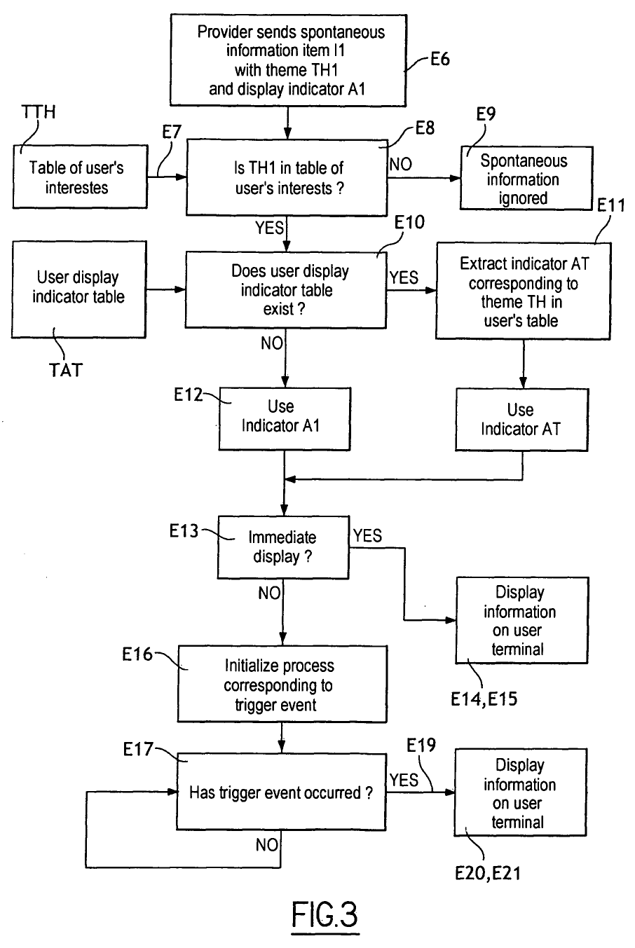

FIG. 3 is a diagram of the method of the invention for automatic processing of spontaneous information;

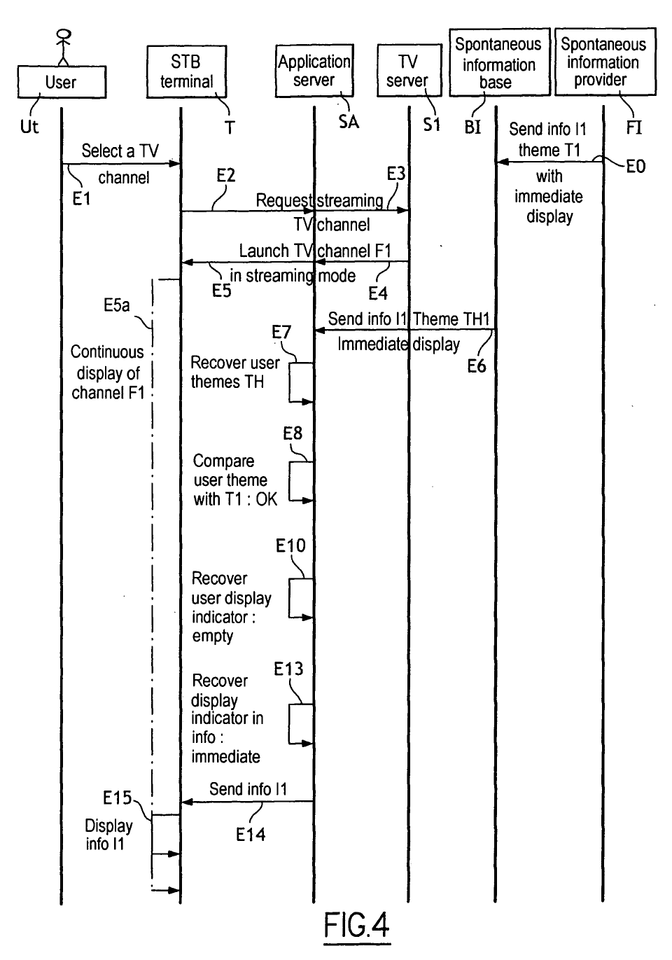

FIG. 4 is a diagram of one example of the method of the invention for automatic processing of spontaneous information in the case of a television multimedia stream; and

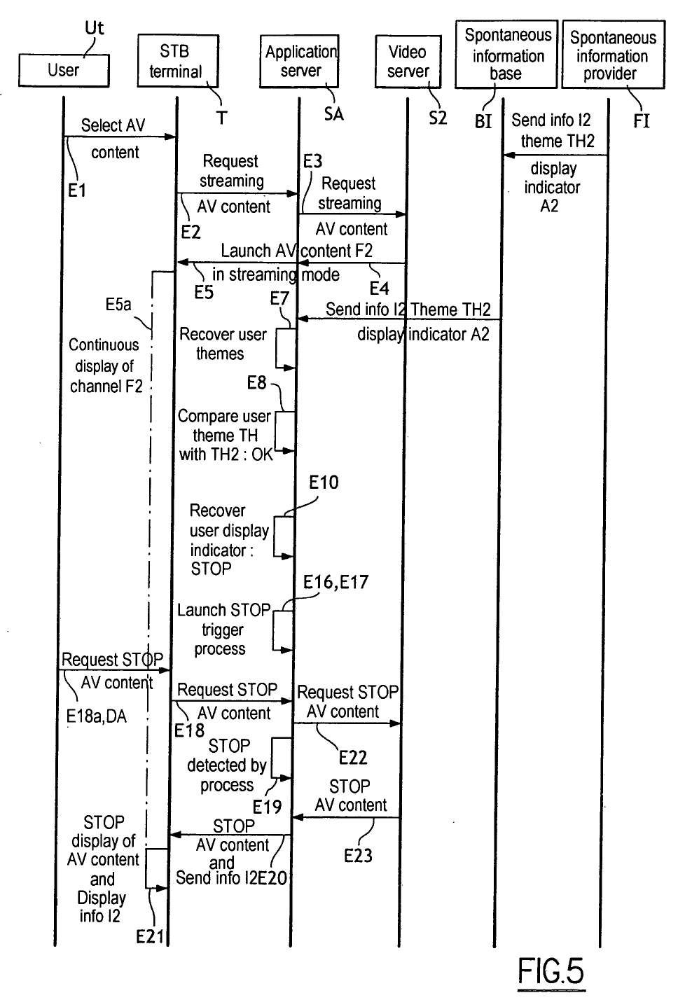

FIG. 5 is a diagram of one example of the method of the invention for automatic processing of spontaneous information in the case of a video on demand multimedia stream.

FIG. 1 shows a user Ut who has a terminal T for reproducing multimedia streams.

The stream conveys a multimedia content that contains information that is meaningful to the user Ut and is intended to be displayed to the user on the terminal T. The term “multimedia” encompasses audio, video, and other information, for example music, film, and more generally any audiovisual or multimedia work.

The reproduction of streams or of information received by the terminal may take the form of display on a screen and/or the reproduction of sound by one or more loudspeakers, for example. In FIG. 1, the reproducer terminal T is a television receiver, for example, where applicable equipped with a decoder or any other kind of set top box (STB). The reproducer terminal T could equally well be a computer having a display monitor and loudspeakers. The multimedia stream originates externally of the reproducer terminal T. For example, the stream originates from a television server S1 or a video on demand server S2 remote from the terminal T. For example, the server S2 also contains a video catalogue and a banner for listing them that are accessible to the terminal T.

The method of the invention proceeds in the following manner.

It is assumed that during the initial step E1 the user Ut selects on the reproducer terminal T a stream F1 or F2 from among those present on the servers S1, S2, for example the film F4 in FIG. 1. Each multimedia stream F1, F2 on the servers S1 and S2 is associated with a respective stream identifier IDF1 IDF2, for example, and in this case the stream F1 or F2 is selected by the user Ut on the reproducer terminal T by means of its identifier IDF1 or IDF2. In the case of a television receiver, for example, the selection is effected by selecting a television channel in the conventional way in a package of television channels received and accessible on-line by STB or PC terminals connected to the Internet, or by selecting the stream identifier from a plurality thereof in a catalogue or in a program guide sent by the server S1 and/or S2 to the terminal T, accessible on-line on the Internet by STB or PC terminals and presented or displayed to the user Ut on the terminal T. For example, each stream identifier IDF1, IDF2 displayed on the screen of the terminal T may be scanned by displaying text or an image illustrating the associated content, for example a poster or synopsis of a film or transmission conveyed by that stream, or an advertising banner, the complementary information being sent to the terminal T with the stream identifier by the server S1 and/or S2. The selection is effected by the user Ut with the aid of a remote controller TC, for example, as shown.

The stream identifier IDF1, IDF2 selected on the terminal T in the step E1 (that of the film F4 in the present example) is sent from the terminal T to a management server SA in the next step E2 in a message requesting the stream that has been selected. Each reproducer terminal T has a reproducer terminal identifier IDT that is stored beforehand in the management server SA and is also specified in the stream request message that it sends to the server SA. The server SA then stores the current stream request message and in the next step E3 sends a stream request F1, F2 corresponding to the identifier IDF1, IDF2 present in the stream request message to the corresponding server S1, S2, respectively.

Having received the stream request, the server S1, S2 then supplies in the step E4 the stream F1, F2 corresponding to the identifier IDF1, IDF2 present therein and in the stream request message to the management server SA, which in the step E5 sends this stream F1, F2 to the terminal T corresponding to the identifier IDT present in the current stream request message stored in the server SA. The streams F1, F2 are sent to the terminal T in streaming mode, for example.

In the step E5a the terminal reproduces the stream F1, F2 received in the step E5, for example by playing the film or the transmission F1, F2 on its display screen and through its loudspeakers, as indicated by the chain-dotted lines in FIGS. 4 and 5, which in this case correspond to the continuous display of the stream F1, F2 on the screen of the terminal T.

It is assumed that there is provision for reproducing spontaneous information I1, I2 on users' terminals in addition to and simultaneously with the streams F1, F2 present on the servers S1 and S2. Spontaneous information I1, I2 may be provided for one or several or all of the streams F1, F2, and may be associated with a specific stream F1 or F2 or independent thereof. The spontaneous information I1, I2 consists of multimedia contents: text messages, animated or fixed images, sound, video, interactive applications. The spontaneous information I1, I2 is produced by one or more providers or operators FI, for example during or following the storage of the streams F1, F2 on the servers S1, S2. Beforehand, during the step E0, i.e. before the step E1 or at least before the step E6 described below, the spontaneous information I1, I2 is sent by the provider(s) FI to one or more bases BI, referred to below by the generic term base BI, and stored therein with a view to sending it to users' terminals. The database BI is remote from the terminal T. The base BI represents a spontaneous information base management system, for example.

In the embodiments shown in the figures and described below, each spontaneous information item I1, I2 is associated with one or more first characteristic(s) CAR1, CAR2 in the spontaneous information base BI. The characteristics CAR1, CAR2 relate to the multimedia content of the associated spontaneous information I1, I2, for example.

The first characteristic CAR1, CAR2 of the spontaneous information I1, I2 may be one or more first themes TH1, TH2 of the multimedia content, for example, such as “adventure”, “suspense”, “thriller”, “sport”, “cop show”, “horror”, “information”, “humor”, “family”, “comedy”, “tragedy”, “drama”, “action”, “fantasy”, “adult”, “youth”, “children”, “music”, “documentary”, “series”, “knowledge”, “film club”, “magazine”, “my region”, “culture”, “entertainment”, “games”, “advertising”, etc.

The first characteristic CAR1, CAR2 of the spontaneous information I1, I2 may equally be a first reproduction indicator A1, A2, for example, such as an indicator of immediate or unconditional reproduction on the terminal T or of non-immediate reproduction commanded by a triggering event selected from a list of triggering events such as, for example: the end of the stream (the end of a program such as a video or a television transmission), stopping or requesting stopping of reproduction of the stream on the terminal T, switching the terminal T to another stream or program (the user Ut “zapping” from one television channel to another, stopping a video on the terminal T, etc.), a predefined time of reproduction on the terminal T (for example, a programmed time in the broadcasting schedule of the base BI, such as midnight on New Year's Eve, the start of a race, etc.), a prescribed time after the reproduction on the terminal T of previous spontaneous information (for example a question, in which case the prescribed time is a time for the user Ut to reflect before answering the question), or the expiry of a predefined period for the reproduction of the spontaneous information on the terminal T. For example, a reproduction indicator A1, A2 is associated with one or several or all of particular theme(s) TH1, TH2. The indicator(s) A1, A2, AT may be indicators of immediate or deferred reproduction.

The spontaneous information characteristics are characteristics of the audiovisual content, for example, and their reproduction corresponds to their display on the screen of the terminal T, for example.

The allocation and storing of the characteristics CAR1, A1, TH1, CAR2, A2, TH2 in the base BI are effected by the provider(s) FI, by provider(s) of the contents of the streams F1 and F2 able to manage the contents on the servers S1 and S2, or by the service provider.

The management server (application server) SA remote from the reproducer terminal T hosts for each terminal T one or more spontaneous information filtering characteristics CART, referred to as second spontaneous information characteristics CART, that are defined by the user Ut, for example by communicating these characteristics to the management server SA from the terminal T. To this end, spontaneous information filtering characteristics CART are associated with the reproducer terminal T, the identifier IDT of the reproducer terminal T being associated in the management server SA with these spontaneous information filtering characteristics CART. In the embodiments shown in the figures, these second characteristics CART include one or more themes or centers of interest TH in a table of interests TTH and/or a second reproduction indicator AT in a reproduction indicator table TAT. These characteristics CART are selected from a group of prescribed spontaneous information filtering characteristics CAR from the server SA and thus, in the foregoing example, from a group of themes TH and a group of reproduction indicators AT. The themes TH1, TH2 of the spontaneous information I1, I2 and the reproduction indicators A1, A2 of the spontaneous information I1, I2 are also prescribed in the same group of themes TH and the same group of reproduction indicators AT, for example, as indicated above.

The tables TTH, TAT are created for the terminal T when the reproducer terminal T is first introduced into service, for example, or when the terminal T first subscribes to the service provided by the invention, as shown in FIG. 2 in the form of a display on a television screen, and is described below.

The apparatus according to the invention is implemented in the following manner, for example. Communication between the terminal T and the server SA is provided by a connection to a computer network, for example, such as the Internet, the terminal T or the set top box STB having corresponding connection means, and the filtering method of the invention is executed, for example, in a multimedia service portal offering a package of television channels and a catalogue of video on demand videos, accessible on-line to the terminals T. The terminal T or the set top box STB incorporates an Internet type web browser, for example, to enable connection to the IP network using the http protocol, display of the pages of the service, management of local interactivity via a remote controller, or display of TV channels or videos in streaming mode and sending of requests to the server SA. The server SA hosts the service portal in the form of HTML/JavaScript pages generated dynamically and is able to consult the database BI. One embodiment of the invention is an ADSL network audiovisual portal intended for STB and PC terminals.

The terminal T is provided with an interface for selecting or modifying the second characteristics CART. To this end, the user first selects his or her own identifier IDT on the terminal T to set up the connection to the server SA or connects to the server directly. The management server SA then switches the terminal T to a display in which the user can choose the filtering characteristics CART, TH, AT from the prescribed filtering characteristics CAR. Those characteristics CAR are stored in the server SA beforehand and are made available therein so that they can be selected in association with the terminal T as characteristics CART. By default, as represented in FIG. 2 by the checked themes TH′ and TH″, the person may be prompted to choose the multimedia content characteristics CAR, which will not be associated with the terminal T, and which therefore will not be second characteristics CART, TH, AT of the terminal T and will be characteristics CAR prohibited to the terminal T. The second characteristics CART, TH, AT of the terminal T are therefore the characteristics defined as being pertinent to the user Ut.

The method is described below with reference to FIG. 4 in the situation where a stream F1 has been selected in the server S1. Of course, what is indicated for S1, F1, IDF1, I1, CAR1, TH1, A1, II1 is equally valid for S2, F2, IDF2, I2, CAR2, TH2, A2, II2 for the situation where, in FIG. 5, a stream F2 has been selected in the server S2 and is reproduced on the terminal T.

In the step E6, the base BI sends the spontaneous information I1 to the management server SA. For example, the base BI comprises for this purpose a schedule for broadcasting the spontaneous information I1 to the users' terminals T. In addition to this or instead of this, the spontaneous information I1 may also refer to an associated stream F1 on the server S1, for example by being stored in the base BI in association with the identifier IDF1 of the stream F1, especially if the spontaneous information I1 is linked to that stream F1. Alternatively, the management server SA is provided beforehand with a table TT associating identifiers IDF1, IDF2 of streams F1, F2 with spontaneous information identifiers II1, II2 associated in the base BI with the spontaneous information I1, I2. In this variant, to receive the spontaneous information I1 in the step E6, after the step E2 the management server SA requests from the base BI the spontaneous information I1, I2 associated therein with the identifier II1 corresponding in the table TT to the identifier IDF1 present in the stream request message received by the server SA.

The spontaneous information I1 sent from the base BI to the management server SA in the step E6 is accompanied by its characteristics CAR1, TH1, A1.

For example, action on the parameters CART of the user Ut takes priority over action on those CAR1, CAR2 of the spontaneous information I1, I2 and the parameters CAR1, CAR2 of the spontaneous information I1, I2 are taken into account by default; in the absence of the parameters CART, CAR1, CAR2, the spontaneous information I1, I2 is reproduced on the terminal T in the steps E14 and E15 described below.

After the step E6, the management server SA looks up the spontaneous information filtering characteristics CART associated with the terminal T, i.e. in the example described above the second characteristics CART associated in the server SA with the identifier IDT previously determined in the current stream request message stored in the server SA.

Using appropriate technical means such as a filter FA, the management server SA then analyses the first characteristic CAR1 received from the base BI for the spontaneous information I1 and the second characteristic CART obtained in this way. The filter FA is represented below by the management server SA.

In the embodiments shown in the figures, in the step E7 the management server SA first looks up the theme(s) TH associated in the table of interests TTH with the identifier IDT of the reproducer terminal T previously determined.

The management server SA then compares the theme TH1 of the spontaneous information I1 with the theme(s) TH of the terminal T in the step E8. If that comparison indicates that the theme TH1 is different from all these themes TH, the spontaneous information I1 is ignored in the step E9 and is not sent to the terminal T to be reproduced thereon. Accordingly, the spontaneous information I1 does not in this case interfere with the reproduction of the stream F1 on the terminal T. In the step E9 the spontaneous information I1 received from the base BI is eliminated from the management server SA, for example. If the above comparison indicates that the theme TH1 is equal to or corresponds to one of the themes TH, the step E10 is executed.

During the step E10, the management server SA consults the reproduction indicators table TAT to find out if there is one associated with the identifier IDT of the reproducer terminal T.

In the event of a positive result in the step E10, in the step E11 the management server SA reads in the table TAT the reproduction indicator AT that is associated with the identifier IDT of the reproducer terminal T and will therefore be used afterwards as a reproduction indicator, and the next step is the step E13. Consequently, if the table TAT contains information for the terminal T, the second indicator AT of that terminal T (indicator AT corresponding to the theme TH=TH1 of the spontaneous information I1) will be taken into account.

In the event of a negative result in the step E10, in the step E12 the management server SA reads the reproduction indicator A1 associated with the spontaneous information I1, which will therefore be used afterwards as a reproduction indicator, and the next step is the step E13. Consequently, if the table TAT contains no information for the terminal T, the first indicator A1 of the spontaneous information I1 will be taken into account.

In the step E13, the management server SA checks if the reproduction indicator AT or A1 used is an immediate reproduction indicator, for example an immediate display indicator. In the event of a negative result in the steps E10 and E12, i.e. if there is no indicator AT or A1 in the table TAT for the terminal T or associated with the information I1, the method proceeds directly from the step E13 to the step E14.

In the event of a positive result in the step E13, as shown in FIG. 4, in the step E14 the spontaneous information I1 is sent immediately by the management server SA to the terminal T, where is reproduced as soon as it is received in the step E15, the terminal T being adapted to reproduce spontaneous information that it receives immediately. In the case of visual spontaneous information I1, it is therefore displayed immediately on the screen of the terminal T.

In the event of a negative result in the step E13, in the step E16 the server SA looks up the predefined triggering event in the reproduction indicator AT or A1 used and in the step E17 waits for that triggering event to occur. For example, signals are sent to the management server SA to communicate the occurrence of the events to it if those events depend on an entity other than the server SA, like the events coming from the terminal T, as will be described below. The triggering event that the server SA waits for in FIG. 5 is, for example, the sending to the management server SA in the step E18, as commanded on the terminal T by the user in the step E18a, of a request DA to stop the reproduction of the stream F2 thereon in the step E5a. Of course, this event could be another of the events referred to above for the indicators A1, A2 or other events.

When the triggering event is detected in step E19 by the management server SA—i.e. in the FIG. 5 example when the management server SA has received the request DA to stop reproduction of the stream F2 from the terminal T in the step E18—the spontaneous information I1, I2 is sent in the step E20 by the management server SA to the terminal T, where it is reproduced as soon as it is received in the step E21. In the case of the FIG. 5 request DA to stop reproduction, the step E18 is also followed in the server SA by a step E22 of sending the request DA to stop reproduction to the server S2 which then brings about therein the stopping of sending of the stream F2 to the terminal T and sends a stop reproduction message to the server SA in the step E23 and then to the terminal T in the step E20.

If the triggering event present in the reproduction indicator AT or A1 used is the end of a predefined period (for example 10 minutes) for deferring reproduction (for example display) on the terminal T, the spontaneous information I1 is retained on the management server SA for that period during the step E17 in FIG. 3, the predefined period is monitored during the step E17 and detected by the management server SA (for example by a clock thereof) in the step E19, which causes the sending of the spontaneous information I1 from the server SA to the terminal T in the step E20, for its reproduction thereon as soon as it is received in the step E21. If the reproduction of the spontaneous information I1, I2 on the terminal T is deferred, the reproduction of the stream F1, F2 in the step E5a is interrupted and deferred for the same time to resume at the point reached at the time of the interruption, or the reproduction of the spontaneous information I1, I2 and the reproduction of the stream F1, F2 in the step E5a on the terminal T are superposed, or the reproduction of the stream F1, F2 on the terminal T in the step E5a is eliminated during the reproduction of the spontaneous information I1, I2 and is not deferred but resumes at the place reached at the end of the reproduction of the spontaneous information I1, I2.

If the triggering event present in the reproduction indicator AT or A1 used is a predetermined time for reproduction (for example display) on the terminal T, the spontaneous information I1 is retained in the management server SA during the step E17 in FIG. 3, the predetermined time is monitored during the step E17 and detected in the step E19 by the management server SA (for example by a clock thereof), which brings about the sending of the spontaneous information I1 from the server SA to the terminal T in the step E20, for its reproduction thereon as soon as it is received in the step E21.

If the triggering event present in the reproduction indicator AT or A1 used is an action of the user on the terminal T and signaled to the management server SA (for example the request DA to stop reproduction in FIG. 5 or the user zapping channels on the terminal T), the spontaneous information I1 is retained in the management server SA during the step E17 in FIG. 3, the management server SA monitors the interaction of the terminal T with the server SA during the step E17 and detects the occurrence of this action in the step E19, which causes the sending of the spontaneous information I1 from the server SA to the terminal T in the step E20, for its reproduction thereon as soon as it is received in the step E21.

Thus the invention provides for the immediate or deferred display of pertinent spontaneous information as a function of criteria A1, A2 defined by the provider of the spontaneous information and as a function of criteria AT defined by the user. The invention also provides for automatic triggering of deferred display of spontaneous information on the occurrence of events selected by the user: ending or stopping of the audiovisual content stream, change of television channel, predetermined time, reception of other spontaneous information, etc.

1. A method of automatically processing spontaneous information intended to be reproduced on a reproducer terminal (T) with a multimedia stream,
the method being characterized in that
each spontaneous information item (I1, 12) is associated with at least one first spontaneous information characteristic (CAR1, CAR2) from a group comprising a plurality of prescribed spontaneous information characteristics (CAR),
the reproducer terminal (T) is associated with at least one second spontaneous information characteristic (CART) from the group comprising a plurality of prescribed spontaneous information characteristics (CAR),
said at least one first spontaneous information characteristics (CAR1, CAR2) of the spontaneous information (I1, 12) comprising at least one first reproduction indicator (A1, A2) intended for the terminal (T) and/or said at least one second spontaneous information characteristic (CART) of the terminal (T) comprising at least one second reproduction indicator (AT) intended for the terminal (T),
the reproduction of a multimedia stream (F1, F2) on the reproducer terminal (T) automatically triggers the sending of the first and the second spontaneous information characteristics (CAR1, CAR2, CART) present to an analysis filter (FA), for sending the spontaneous information (I1, 12) to the reproducer terminal (T) or not, as a function at least of the first and the second spontaneous information characteristics (CAR1, CAR2, CART) sent to the analysis filter (FA),
the analysis filter (FA), in the event of authorization, commanding (E13, E16, E17) the sending (E14, E20) of the spontaneous information (I1, 12) to the reproducer terminal (T) in conformance with the second reproduction indicator (AT) of the terminal (T) or, in the absence of the second reproduction indicator (AT) of the terminal (T), in conformance with the first reproduction indicator (A1, A2) of the spontaneous information (I1, 12),
the reproducer terminal (T) reproducing the spontaneous information (I1, 12) when it has been sent to it.

2. An automatic processing method according to claim 1, characterized in that the first reproduction indicator (A1, A2) of the spontaneous information (I1, 12) and/or the second reproduction indicator (AT) of the terminal (T) are each selected from an indicator of immediate reproduction on the terminal (T) to command the immediate sending (E14) of the spontaneous information (I1, 12) to the reproducer terminal (T) and an indicator of non-immediate reproduction to command the sending (E20) of the spontaneous information (I1, 12) to the reproducer terminal (T) in the event of detection (E19) of a particular triggering event by the analysis filter (FA).

3. A processing method according to claim 2, characterized in that the triggering event is one of the following events: the end of the reproduction of the multimedia stream (F1, F2) on the terminal (T), the sending on the terminal (T) of a request for stopping the reproduction of the stream (F1, F2), the stopping on the terminal (T) of the reproduction of the stream (F1, F2), the switching of the terminal (T) to another stream (F1, F2) or program, a predefined time of reproduction of the spontaneous information (I1, 12) on the terminal (T), a prescribed period for deferring the reproduction of the spontaneous information (I1, 12) on the terminal (T), a prescribed period for deferring the reproduction of the spontaneous information (I1, 12) on the terminal (T) after the reproduction thereon of a previous spontaneous information item, and an action of the user on the terminal (T).

4. A processing method according to claim 1, characterized in that said at least one first spontaneous information characteristic (CAR1, CAR2) of the spontaneous information (I1, I2) comprises at least one first theme (TH1, TH2) relating to a spontaneous information multimedia content and at least one second spontaneous information characteristic (CART) of the terminal (T) comprises at least one second theme (TH) relating to a spontaneous information multimedia content,
the analysis filter (FA) comparing (E8) the first theme (TH1, TH2) of the spontaneous information (I1, 12) to the second theme (TH) of the terminal (T) to authorize sending (E14, E20) the spontaneous information (I1, 12) to the reproducer terminal (T) if the comparison (E8) determines that the first theme (TH1, TH2) is found in the second theme (TH) and not to authorize sending (E9) the spontaneous information (I1, I2) to the reproducer terminal (T) if the comparison (E8) determines that the first theme (TH1, TH2) is not found in the second theme (TH).

5. A processing method according to claim 1, characterized in that
the second spontaneous information characteristic (CART) is associated with an identifier (IDT) of the reproducer terminal (T) on a management server (SA) remote from the reproducer terminal (T) in at least one table (THT, TAT), the analysis filter (FA) being in the management server (SA), and
the reproduction of the multimedia stream (F1, F2) on the reproducer terminal (T) automatically triggers consultation by the analysis filter (FA) of the second spontaneous information characteristic (CART) associated with the identifier (IDT) of the reproducer terminal (T) in the identification table (THT, TAT).

6. A processing method according to claim 5, characterized in that the association of the second spontaneous characteristic (CART) with the identifier (IDT) of the reproducer terminal (T) in the table (THT, TAT) is executed from the reproducer terminal (T).

7. A processing method according to claim 6, characterized in that
the second theme (TH) of the terminal (T) is associated with the identifier (IDT) of the reproducer terminal (T) in a table (TTH) of interests in the management server (SA), and/or
the second reproduction indicator (AT) of the terminal (T) is associated with the identifier (IDT) of the reproducer terminal (T) in a table (TAT) of indicators in the management server, and
the reproduction of the multimedia stream (F1, F2) on the reproducer terminal (T) automatically triggers consultation by the analysis filter (FA) of the second theme (TH) associated with the identifier (IDT) of the reproducer terminal in the table (THT) of interests and, in the event of authorization (E10) to send (E14, E20) the spontaneous information (I1, 12), triggers consultation by the analysis filter (FA) of the second reproduction indicator (AT) associated with the identifier (IDT) of the reproducer terminal (T) in the table (TAT) of indicators or, in the absence of a second reproduction indicator (AT), consultation by the analysis filter (FA) of the first reproduction indicator (A1, A2).

8. A processing method according to claim 1, characterized in that
the first spontaneous information characteristic (CAR1, CAR2) is associated with the spontaneous information (I1, 12) in a database (BI) remote from the reproducer terminal (T) providing the spontaneous information (I1, 12) and
the reproduction of the multimedia stream (F1, F2) on the reproducer terminal (T) automatically triggers consultation by the analysis filter (FA) of the first spontaneous information characteristic (CAR1, CAR2) associated with the spontaneous information (I1, 12) in the database (BI).

9. Apparatus for implementing the automatic processing method according to claim 1 to process automatically spontaneous information intended to be reproduced on a reproducer terminal (T) with a multimedia stream, the apparatus being characterized in that it includes:
at least one database (BI) remote from the reproducer terminal (T) for providing spontaneous information (I1, 12) and in which each spontaneous information item (I1, I2) is associated with at least one first spontaneous information characteristic (CAR1, CAR2) from a group of prescribed spontaneous information characteristics (CAR),
at least one remote management server (SA) for associating with the production terminal (T), in at least one table (TTH, TAT), at least one second spontaneous information characteristic (CART) from the group of prescribed spontaneous information characteristics (CAR), said at least one first spontaneous information characteristic (CAR1, CAR2) of the spontaneous information (I1, 12) comprising at least one first reproduction indicator (A1, A2), intended for the terminal (T), and/or said at least one second spontaneous information characteristic (CARD) of the terminal (T) comprising at least one second reproduction indicator (AT), intended for the terminal T,
means for automatically triggering in the management server (SA), when a multimedia stream (F1, F2) is reproduced on the reproducer terminal (T), consultation of the first characteristic (CAR1, CAR2) associated with the spontaneous information (I1, 12) in the database (BI) and of the second characteristic (CART) associated with reproducer terminal (T) in the table (TTH, TAT), and sending to an analysis filter (FA) in the management server (SA) of the first and second characteristics (CAR1, CAR2, CART) obtained, the analysis filter including means for sending or not sending the spontaneous information (I1, 12) to the reproducer terminal (T) as a function at least of the first and second characteristics (CAR1, CAR2, CART) sent to the analysis filter (FA), and, in the event of authorization, for commanding (E13, E16, E17) the sending (E14, E20) to the reproducer terminal (T) of the spontaneous information (I1, 12) in conformance with the second reproduction indicator (AT) of the terminal (T) or the first reproduction indicator (A1, A2) of the spontaneous information (I1, I2) in the absence of a second reproduction indicator (AT) of the terminal (T), the reproducer terminal (T) including means for reproducing the spontaneous information (I1, I2) when it has been sent to it.

10. Processing apparatus according to claim 9, characterized in that the first reproduction indicator (A1, A2) of the spontaneous information (I1, 12) and/or the second reproduction indicator (AT) of the terminal (T) are each chosen from an indicator of immediate reproduction on the terminal (T) to command the immediate sending (E14) of the spontaneous information (I1, 12) to the reproducer terminal (T) and an indicator of non-immediate reproduction to command the sending (E20) of the spontaneous information (I1, 12) to the reproducer terminal (T) in the event of detection (E19) of a particular triggering event by the analysis filter (FA).

11. Processing apparatus according to claim 10, characterized in that means are provided for sending signals to the management server (SA) to communicate to it the occurrence of events originating from the reproducer terminal (T).

12. A management server (SA) for automatically processing spontaneous information intended to be reproduced on a reproducer terminal (T) with a multimedia stream,
the server being characterized in that it comprises:
means for receiving spontaneous information (I1, 12) from at least one data base (BI) for supplying spontaneous information (I1, 12), each spontaneous information item (I1, 12) being associated with at least one first spontaneous information characteristic (CAR1, CAR2) from a group comprising a plurality of prescribed spontaneous information characteristics (CAR), said at least one first spontaneous information characteristic (CAR1, CAR2) of the spontaneous information (I1, 12) comprising at least a first reproduction indicator (A1, A2) for the terminal (T);
means for associating the reproducer terminal (T), in at least one table (TTH, TAT), with at least one second spontaneous information characteristic (CART) from the group of a plurality of prescribed spontaneous information characteristics (CAR), said at least one second spontaneous information characteristic (CART) of the terminal (T) comprising at least one second reproduction indicator (AT) for the terminal (T); and
an analysis filter (FA) including means for sending or not sending to the reproducer terminal (T), as a function of at least the first and second characteristics (CAR1, CAR2, CART) sent to the analysis filter (FA), the spontaneous information (I1, 12), and, when authorized, for commanding (E13, E16, E17) the spontaneous information (I1, I2) to be sent (E14, E20) to the reproducer terminal (T) in conformance with the second reproduction indicator (AT), or in the absence of the second reproduction indicator (AT), to send the first reproduction indicator (A1, A2).

13. A reproduction terminal (T) for co-operating with a management server according to claim 12, characterized in that it includes means for reproducing the spontaneous information (I1, I2) when it has been sent thereto.

14. A signal for automatically processing spontaneous information that is to be reproduced on a reproducer terminal (T), the signal being characterized in that it comprises at least a first spontaneous information characteristic (CAR1, CAR2) comprising at least a first reproduction indicator (A1, A2) for the terminal (T), said at least one first reproduction indicator (A1, A2) being taken by default in the absence of at least one second reproduction indicator (AT) included in at least one second spontaneous information characteristic (CART) associated with said reproduction terminal (T).
